(19) United States
(12) Patent Application Publication
(10) Pub. No.: US 2026/0322248 A1
(43) Pub. Date: Oct. 15, 2026

(54) SWITCH CONVERTER, AND CONTROL CIRCUIT AND CONTROL METHOD THEREOF

(71) Applicant: SG MICRO CORP, Beijing (CN)

(72) Inventors: Xinmin YI, Beijing (CN); Liwei JIA, Beijing (CN); Haifeng XU, Beijing (CN)

(21) Appl. No.: 19/485,472

(22) PCT Filed: May 11, 2024
(86) PCT No.: PCT/CN2024/092601

§ 371 Date: Nov. 18, 2025

(30) Foreign Application Priority Data
Jun. 30, 2023 (CN) 202310796924.6

(51) Int. Cl. H02M 1/14; H02M 1/00; H02M 3/157; H02M 3/158

(52) U.S. Cl. CPC H02M 1/14; H02M 1/0019; H02M 1/0025; H02M 3/157; H02M 3/158

(57) ABSTRACT

A switch converter and a control circuit and a control method therefor are disclosed. The control circuit comprises: an error signal generation unit, for generating an error signal; a PFM control unit, for generating a first control signal generating a second control signal according to a first feedback voltage, a second reference voltage and a first control signal, and generating a first set signal according to the second control signal and a first clock signal; a reset signal generation unit, for generating a first reset signal by use of a ramp voltage and the error signal; a logic and drive unit, for controlling the on and off of the high-side transistor according to the first set signal and the first reset signal, wherein the second control signal is related to a load level of the switch converter, so as to accurately set the timing to enter PFM mode.

### CROSS-REFERENCE TO RELATED APPLICATIONS

This application is a Section 371 National Stage Application of International Application No. PCT/CN2024/092601, filed on May 11, 2024, entitled “SWITCH CONVERTER AND CONTROL CIRCUIT AND CONTROL METHOD THEREFOR”, and published as WO 2025/001543A1 , published Jan. 2, 2025, which claims priority to Chinese Patent Application No. 202310796924.6, filed on Jun. 30, 2023, the entire contents of which are incorporated herein by reference in their entireties.

### FIELD OF TECHNOLOGY

The present disclosure relates to a technical field of electronic circuits, particularly, to a switch converter and control circuit and control method therefor.

### BACKGROUND

Switch converters have been widely applied in various fields and have become an indispensable part of people's daily life.

In traditional voltage-mode controlled switch converters, the switch converter operates in continuous conduction mode (CCM) under heavy load, but transitions to discontinuous conduction mode (DCM) when the load shifts from heavy to light. In DCM mode, switch converters typically employ Pulse Frequency Modulation (the control signal PFM) modulation technology. However, due to the absence of inductor current sampling information in the circuit and the slow loop response inherent to voltage-mode circuit architecture, the load level at which the switch converter enters PFM mode is difficult to control accurately. Additionally, PFM mode exhibits slow response during load transients, uneven pulse generation, and causes significant output ripple and voltage overshoot, which imposes clear limitations in practical applications.

Therefore, there remains a need to propose a new switch converter and control circuit therefor to address the above-mentioned problems.

### SUMMARY OF THE PRESENT DISCLOSURE

In view of the above-mentioned problems, an objective of the present disclosure is to provide a switch converter and control circuit and control method therefor, so as to facilitate accurate setting of the timing to enter PFM mode.

According to an aspect of the present disclosure, there is provided a control circuit for a switch converter, wherein the switch converter comprises a high-side transistor and an inductor, the control circuit controls an energy transfer from an input voltage to an output voltage by controlling on and off of the high-side transistor, and the control circuit comprises: an error signal generation unit, for generating an error signal has a voltage magnitude being negatively correlated with a difference according to the difference between a first feedback voltage of the output voltage of the switch converter and a first reference voltage when a first control signal is in an invalid state, and setting the voltage magnitude of the error signal to a first preset value when the first control signal is in a valid state; a PFM control unit, for generating the first control signal according to a magnitude relationship between the first feedback voltage and the first reference voltage, a magnitude relationship between the first feedback voltage and a third reference voltage, and the error signal, generating a second control signal according to a magnitude relationship between the first feedback voltage and a second reference voltage and the first control signal, and generating a first set signal according to the second control signal and a first clock signal, wherein the second reference voltage is greater than the first reference voltage and less than the third reference voltage; a reset signal generation unit, for generating a ramp voltage, and generating a first reset signal by use of the ramp voltage and the error signal;
a logic and drive unit, for controlling the on and off of the high-side transistor according to the first set signal and the first reset signal, wherein the second control signal is related to a load level of the switch converter.

Optionally, the PFM control unit is configured to: when the first control signal is in the invalid state, if a voltage magnitude of the error signal meets a preset condition, control the first control signal to change to the valid state; when the first control signal is in the invalid state, if the first feedback voltage is greater than the third reference voltage, control the first control signal to change to the valid state; when the first control signal is in the valid state, if the first feedback voltage is less than the first reference voltage, control the first control signal to change to the invalid state.

Optionally, the preset condition comprises a sum of the voltage magnitude of the error signal and a second feedback voltage of the output voltage being less than a second preset value; wherein, when the sum of the voltage magnitude of the error signal and the second feedback voltage of the output voltage is equal to the second preset value, if the switch converter is in DCM mode, an equivalent duty cycle of the high-side transistor of the switch converter reaches a preset ratio with the equivalent duty cycle of the high-side transistor of the switch converter in CCM mode, and the preset ratio is less than 1.

Optionally, the PFM control unit comprises: a first comparator having a non-inverting input receiving the first reference voltage, an inverting input receiving the first feedback voltage, and an output for providing a first comparison signal; a first buffer having a non-inverting input receiving the second feedback voltage of the output voltage, an inverting input being grounded, a first output receiving the error signal, and a second output for providing a duty cycle signal, the duty cycle signal being obtained by superimposing the second feedback voltage of the output voltage and the error signal, the second feedback voltage of the output voltage being greater than the first feedback voltage of the output voltage; a second comparator having a non-inverting input receiving a second preset value, an inverting input receiving the duty cycle signal, and an output terminal for providing a second comparison signal; a third comparator having a non-inverting input receiving the first feedback voltage, an inverting input receiving the third reference voltage, and an output for providing a third comparison signal; an OR gate having a first input receiving the third comparison signal, a second input receiving the second comparison signal, and an output for providing a first logic signal; a first AND gate having a first input receiving the first logic signal, a second input receiving a clock signal, and an output for providing a second set signal; a first flip-flop having a reset terminal receiving the first comparison signal, a set terminal receiving the second set signal, and an output for providing the first control signal;
a fourth comparator having a non-inverting input receiving the first feedback voltage, an inverting input receiving the second reference voltage, and an output for providing a fourth comparison signal; a second AND gate having a first input receiving the fourth comparison signal, a second input receiving the first control signal, and an output for providing the second control signal; a NOR gate having a first input receiving the clock signal, a second input receiving the second control signal, and an output for providing the first set signal.

Optionally, the error signal generation unit comprises: a first transconductance amplifier having a non-inverting input receiving the first feedback voltage of the output voltage and an inverting input receiving the first reference voltage, and the first transconductance amplifier being configured to differentially amplify the first feedback voltage of the output voltage and the first reference voltage; an amplification unit for amplify an output of the first transconductance amplifier; a compensation unit for compensating an output of the amplification unit; an output unit, comprising: a second transconductance amplifier having a non-inverting input receiving a fourth reference voltage and an inverting input connected to the compensation unit; a first switch connected between the non-inverting input and the inverting input of the second transconductance amplifier; and a first reference voltage source and a second switch sequentially connected between the output terminal of the second transconductance amplifier and ground, the first reference voltage source being used to provide the first preset value, wherein the first switch and the second switch are controlled by the first control signal.

Optionally, the reset signal generation unit is configured to: generate the ramp voltage with a first slope according to a second clock signal when the first control signal is in the invalid state; generate the ramp voltage with a second slope according to the second clock signal when the first control signal is in the valid state, the first slope being less than the second slope.

Optionally, the reset signal generation unit comprises: a third switch having a first terminal receiving a third feedback voltage of the input voltage, a second terminal connected to a first node, and a control terminal receiving the first control signal; a fourth switch having a first terminal receiving a fourth feedback voltage of the input voltage, a second terminal connected to the first node, the third feedback voltage of the input voltage being greater than the fourth feedback voltage of the input voltage; an inverter, connected between the first control signal and a control terminal of the fourth switch; a third transconductance amplifier having a non-inverting input connected to the first node and an inverting input being grounded, configured to differentially amplify a voltage at the first node and a ground voltage to obtain a differential signal; a first capacitor having a first terminal connected to an output of the third transconductance amplifier and a second terminal being grounded; a fifth switch having a first terminal connected to the first terminal of the first capacitor, a second terminal being grounded, and a control terminal receiving a second clock signal; a second buffer having a non-inverting input connected to the first terminal of the fifth switch, an inverting input being grounded, a first output being grounded through a second reference voltage source, and a second output for outputting a voltage obtained by superimposing a voltage at the first terminal of the fifth switch and a voltage provided by the second reference voltage source; a third buffer having a non-inverting input connected to the output voltage, an inverting input being grounded, a first output receiving the error signal, and a second output for outputting a voltage obtained by superimposing the output voltage and the error signal; a fifth comparator having a non-inverting input connected to the second output of the second buffer, an inverting input connected to the second output terminal of the third buffer, and an output for providing the first reset signal.

Optionally, the logic and drive unit comprises: a second flip-flop having a set terminal receiving the first set signal, a reset terminal receiving the first reset signal, and an output for providing a PWM signal; a drive circuit, configured to provide a drive signal according to the PWM signal to control the on and off of the high-side transistor.

According to a second aspect of the present disclosure, there is provided a switch converter, comprising: the above-mentioned control circuit; and a power stage circuit, comprising: a high-side transistor and an inductor, the power stage circuit controlling the energy transfer from the input voltage to the output voltage by controlling the on and off of the high-side transistor.

According to a third aspect of the present disclosure, there is provided a control method for a switch converter, wherein the switch converter comprises a high-side transistor and an inductor, the control circuit controls an energy transfer from an input voltage to an output voltage by controlling on and off of the high-side transistor, and the control method comprises: generating an error signal has a voltage magnitude being negatively correlated with a difference according to the difference between a first feedback voltage of the output voltage of the switch converter and a first reference voltage when a first control signal is in an invalid state, and setting the voltage magnitude of the error signal to a first preset value when the first control signal is in a valid state; generating the first control signal according to a magnitude relationship between the first feedback voltage and the first reference voltage, a magnitude relationship between the first feedback voltage and a third reference voltage, and the error signal, generating a second control signal according to a magnitude relationship between the first feedback voltage and a second reference voltage and the first control signal, and generating a first set signal according to the second control signal and a first clock signal, wherein the second reference voltage is greater than the first reference voltage and less than the third reference voltage; generating a ramp voltage, and generating a first reset signal by use of the ramp voltage and the error signal; controlling the on and off of the high-side transistor according to the first set signal and the first reset signal, wherein the second control signal is related to a load level of the switch converter.

The switch converter and control circuit and control method therefor according to the present disclosure can determine the timing to enter PFM mode based on load variation speed after transitioning from CCM to DCM mode during load reduction. When the load changes slowly, the switch converter enters PFM mode by use of variation of the error signal; when the load undergoes sudden change, the switch converter enters PFM mode based on the magnitude relationship between the first feedback voltage and the third reference voltage. Therefore, the load level for entering PFM mode could be accurately set, and fast response of the switch converter during both gradual and abrupt load changes is ensured. Further, synchronized operation between the first control signal and the first clock signal during entering PFM mode is to facilitate uniform pulse generation.

In a preferred embodiment, the switch converter and control circuit therefor further set an operating voltage of the error signal according to a logic state of the first control signal, thereby reducing output voltage ripple in PFM mode and accelerating loop recovery speed when exiting PFM mode.

### BRIEF DESCRIPTION OF THE DRAWINGS

Through the following description of the embodiments of the present disclosure with reference to the accompanying drawings, the above and other objectives, features, and advantages of the present disclosure will be more apparent, in the accompanying drawings:

FIG. 1 shows a structural schematic diagram of a switch converter according to an embodiment of the present disclosure;

FIG. 2 shows a structural schematic diagram of the control circuit of the switch converter according to an embodiment of the present disclosure;

FIG. 3 shows a circuit schematic diagram of the error signal generation unit according to an embodiment of the present disclosure;

FIG. 4 shows a circuit schematic diagram of the PFM control unit according to an embodiment of the present disclosure;

FIG. 5 shows a circuit schematic diagram of the reset signal generation unit according to an embodiment of the present disclosure;

FIG. 6 shows a circuit schematic diagram of the logic and drive unit according to an embodiment of the present disclosure;

FIG. 7 shows a timing diagram of the switch converter according to an embodiment of the present disclosure;

FIG. 8 shows a flowchart of the control method for the switch converter according to an embodiment of the present disclosure.

### DETAILED DESCRIPTION OF THE PRESENT DISCLOSURE

The present disclosure will be described in greater detail with reference to the drawings. Like components or units in various drawings are indicated by like or similar reference numerals. For clarity, the drawings are not to scale.

It should be understood that in the following description, “circuit” may comprise single or combined hardware circuits, programmable circuits, state machine circuits, and/or elements storing instructions executed by programmable circuits. When an element or circuit is said to be “connected to” another element or “connected between” two nodes, it may be directly coupled to the other element or have intervening elements, with connections being physical, logical, or a combination therefor. Conversely, “directly coupled to” or “directly connected to” indicates no intervening elements.

The specification and claims use certain terms to refer to specific components. Those skilled in the art will appreciate that different names may be used by hardware manufacturers for the same component. The specification and claims distinguish components based on functional differences rather than name variations.

The term “semiconductor structure” refers to the collective structure formed during manufacturing steps of a storage device, including all layers or regions already formed. The following description comprises many specific details such as device structure, materials, dimensions, processing techniques and technologies to provide clearer understanding. However, those skilled in the art will appreciate that the present disclosure may be implemented without these specific details.

Additionally, relational terms such as “first” and “second” used herein are merely for distinguishing one entity or operation from another, not necessarily implying actual relationships or order. The term “comprising”, “including” or variations therefor are intended to cover non-exclusive inclusions, meaning a process, method, article, or device including a list of elements will contain those elements but not preclude other elements or inherent elements. The stated “comprising a ...” does not exclude additional identical elements in processes, methods, articles, or devices including the element.

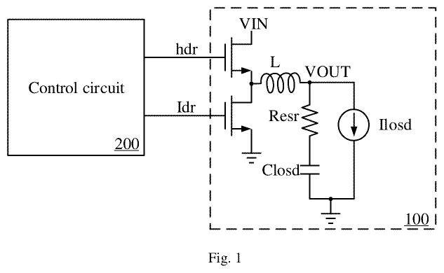

FIG. 1 shows a circuit schematic of a switch converter according to an embodiment of the present disclosure. As shown in FIG. 1, the switch converter comprises a power stage circuit 100 and a control circuit 200.

The power stage circuit 100 comprises a high-side transistor MH and a low-side transistor ML connected in sequence between an input voltage VIN and ground, an inductor L connected between a common node of the high-side transistor MH and the low-side transistor ML and an output voltage VOUT, an equivalent series resistor Reser and a load capacitor Cload connected in sequence between the output voltage VOUT and ground, and a current source Iload connected between the output voltage VOUT and ground. The power stage circuit 100 is configured to control energy transfer from the input voltage VIN to the output voltage VOUT through alternating conduction of the high-side transistor MH and the low-side transistor ML. The present disclosure does not limit the specific structure of power stage circuit 100, and the low-side transistor ML may be replaced by a rectifier diode.

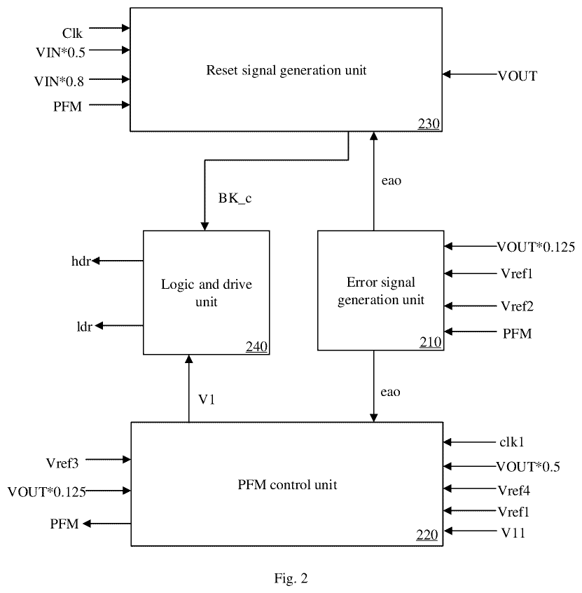

FIG. 2 shows a structural schematic of the control circuit of the switch converter according to an embodiment of the present disclosure. As shown, the control circuit 200 comprises an error signal generation unit 210, a PFM control unit 220, a reset signal generation unit 230, and a logic and drive unit 240.

The error signal generation unit 210 is configured to generate an error signal eao negatively correlated with a difference according to the difference between a first feedback voltage VOUT*0.125 of output voltage VOUT and a reference voltage Vref1 when a control signal PFM is in an invalid state, and set the error signal eao to a first preset value when the control signal PFM is in a valid state. Wherein, when the control signal PFM is in the invalid state, the error signal eao represents an equivalent duty cycle of the high-side transistor MH. For example, the control signal PFM is in the valid state at logic 1 and is in the invalid state at logic 0, and the first preset value is, for example, 1.1V.

The PFM control unit 220 is configured to generate the control signal PFM according to a magnitude relationship between the first feedback voltage VOUT*0.125 and a reference voltage Vref1, a magnitude relationship between the first feedback voltage VOUT*0.125 and a reference voltage Vref4 (e.g., the reference voltage Vref1+30 mV), and the error signal eao, generate a control signal PFM_OSC_D control signal according to a magnitude relationship between the first feedback voltage VOUT*0.125 and a reference voltage Vref3 (e.g., the reference voltage Vref1+10mV) and the control signal PFM, and generate a set signal V1 according to the control signal PFM_OSC_D and a clock signal clk1.

When the control signal PFM is in the invalid state, the PFM control unit 220 controls the control signal PFM to become valid if a voltage magnitude the error signal eao meets a preset condition. That is, the switch converter is controlled to enter PFM mode.

The preset condition comprises a sum of the voltage magnitude of the error signal eao and a second feedback voltage VOUT*0.5 being less than a second preset value (e.g., 1.1V). When the sum of the voltage magnitude of the error signal eao and the second feedback voltage VOUT*0.5 is equal to the second preset value, if the switch converter is in DCM mode, an equivalent duty cycle of the high-side transistor of the switch converter reaches a preset ratio with the equivalent duty cycle of the high-side transistor of the switch converter in CCM mode. Wherein, the preset ratio is less than 1. In the present embodiment, since the second feedback voltage of the output voltage VOUT is VOUT*0.5, the preset ratio is 1:2. However, in actual applications, the preset ratio could be set to any value from 40% to 60%, and the preset ratio could be adjusted by adjusting the second feedback voltage of the output voltage VOUT.

When the control signal PFM is in the invalid state, the PFM control unit 220 is further configured to control the control signal PFM to become valid if the first feedback voltage VOUT*0.125 of the output voltage VOUT is greater than the reference voltage Vref4. That is, the switch converter is controlled to enter PFM mode. That is, the switch converter is controlled to enter PFM mode.

When the control signal PFM is in the valid state, the PFM control unit 220 is configured to control the control signal PFM to become invalid if the first feedback voltage VOUT*0.125 of the output voltage VOUT is less than the reference voltage Vref1. That is, the switch converter is controlled to exit PFM mode.

The reset signal generation unit 230 is configured to generate a ramp voltage RAMP_BK and generate a reset signal BK_c by use of the ramp voltage RAMP_BK and the error signal eao.

Further, the reset signal generation unit 230 could generate the the reset signal BK_c by comparing an equivalent ramp RAMP with the error signal eao. The equivalent ramp RAMP is related to the input voltage VIN and the output voltage VOUT, with an initial value of 1.1V-k*VOUT/fsw (k being a coefficient of VOUT through a buffer 2213, fsw being a switching frequency of the high-side transistor MH).

The logic and drive unit 240 is configured to control the on and off of the high-side transistor MH and the low-side transistor ML according to the set signal V1 and the reset signal BK_c.

After entering PFM mode, the PFM control unit 220 controls the logic and drive unit 240 according to load level of the switch converter to control the conduction of the high-side transistor MH.

Wherein, when the first feedback voltage VOUT*0.125 of the output voltage VOUT is less than the reference voltage Vref3, that is, when the switch converter is relatively heavy load, the control signal PFM_OSC_D is zero, the set signal V1 follows the clock signal clk1, the clock signal clk is reset immediately, and the high-side transistor MH turns on. When the first feedback voltage VOUT*0.125 of the output voltage VOUT is greater than the reference voltage Vref3, that is, when the switch converter is relatively light load, the control signal PFM_OSC_D is the control signal PFM (logic 1), the clock signal clk1 is masked, and the set signal V1 is zero. When the set signal V1 follows the clock signal clk1, the set signal V1 becomes 1 at the falling edge of the clock signal clk1 to turn on the high-side transistor MH, and the set signal V1 becomes 0 at the rising edge of the clock signal clk1. The clock signal clk1 and the clock signal clk are inverted.

When the control signal PFM is in the invalid state, the reset signal generation unit 230 generates the ramp voltage RAMP_BK with a first slope according to the clock signal clk; when the first control signal PFM is in the valid state, the reset signal generation unit 230 generates the ramp voltage RAMP_BK with a second slope according to the clock signal clk, the first slope is less than the second slope.

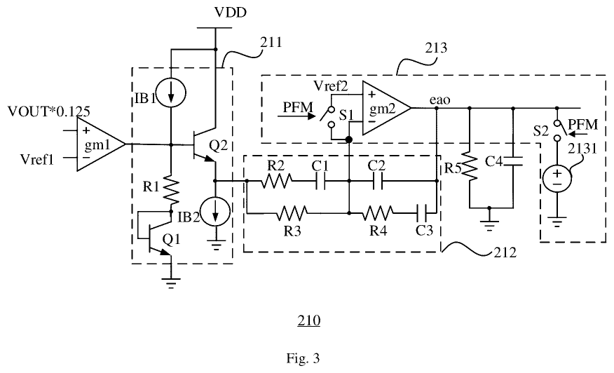

FIG. 3 shows a circuit schematic of the error signal generation unit according to an embodiment of the present disclosure. As shown in FIG. 3, the error signal generation unit 210 comprises a transconductance amplifier gm1, an amplification unit 211, a compensation unit 212, an output unit 213, a resistor R5 and a capacitor C4.

The transconductance amplifier gm1 has a non-inverting input for receiving the first feedback voltage VOUT*0.125 and an inverting input for receiving the reference voltage Vref1, and is configured to differentially amplify the first feedback voltage VOUT*0.125 of the output voltage VOUT and the reference voltage Vref1.

The amplification unit 211 comprises a bias current source IB1, a resistor R1 and a transistor Q1 connected in sequence between a power supply voltage VDD and ground, and transistor Q2 and bias current source IB2 connected in sequence between the power supply voltage VDD and ground. Wherein, a first terminal and a control terminal of the transistor Q1 are connected, and a control terminal of the transistor Q2 is connected to an output of the transconductance amplifier gm1. The amplification unit 211 is configured to amplify an output signal of the transconductance amplifier gm1.

The compensation unit 212 comprises a resistor R2, a capacitor C1 and a capacitor C2 connected in sequence between the second terminal of the transistor Q2 and an output of a transconductance amplifier gm2, and a resistor R3, a resistor R4 and a capacitor C3 connected in sequence between the second terminal of the transistor Q2 and the output of the transconductance amplifier gm2. The compensation unit 212 is configured to compensate an output signal of the amplification unit 211.

The resistor R5 and the capacitor C4 are connected in parallel between the output of the transconductance amplifier gm2 and ground.

The output unit 213 comprises the transconductance amplifier gm2, a switch S1, a switch S2, and a reference voltage source 2131. The transconductance amplifier Gm2 has a non-inverting input for receiving the reference voltage Vref2 and an inverting input connected to a common node of the capacitor C1 and the capacitor C2 and a common node of the resistor R3 and the resistor R4. The switch S1 is connected between the non-inverting input and the inverting input of the transconductance amplifier gm2. The switch S2 and the reference voltage source 2131 are connected in sequence between the output of the transconductance amplifier gm2 and ground. The switch S1 and the switch S2 are controlled by the control signal PFM.

The output unit 213 is configured to set an operating voltage of the error signal eao according to a voltage level of the control signal PFM. When the control signal PFM=1, the switch S1 and the switch S2 are on, and the operating voltage of the error signal eao is set to be the first preset value (for example, 1.1V) through the reference voltage source 2131 to reduce ripple of the output voltage VOUT in DCM mode. When the control signal PFM=0, the switch S1 and the switch S2 are off, and the operating voltage of the error signal eao is set to be at a static operating voltage of CCM mode through the reference voltage Vref2.

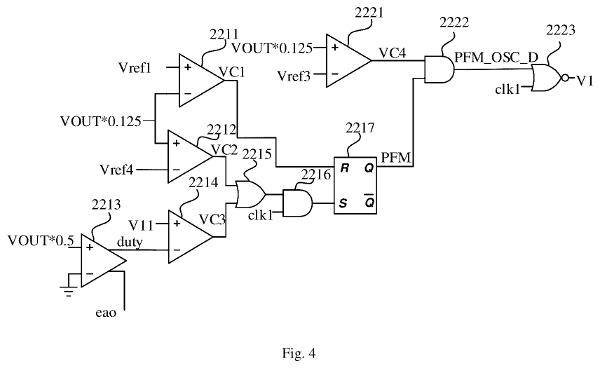

FIG. 4 shows a circuit schematic of the PFM control unit according to an embodiment of the present disclosure. As shown in FIG. 4, the PFM control unit 220 comprises a comparator 2211, a comparator 2212, a buffer 2213, a comparator 2214, an OR gate 2215, an AND gate 2216, a RS flip-flop 2217, a comparator 2221, an AND gate 2222 and a NOR gate 2223.

The comparator 2211 has a non-inverting input for receiving the reference voltage Vref1 and an inverting input for receiving the first feedback voltage VOUT*0.125 of the output voltage VOUT, and is configured to output a comparison signal VC1 according to a comparison result of the reference voltage Vref1 and the first feedback voltage VOUT*0.125 of the output voltage VOUT to determine an operation mode of an inductor current IL. The comparison signal VC1=1 indicates the load is heavy load, and the inductor current IL operates in CCM mode. The comparison signal VC1=0 indicates the load is light load, and the inductor current IL operates in DCM mode.

The comparator 2212 has a non-inverting input for receiving the first feedback voltage VOUT*0.125 of the output voltage VOUT and an inverting input for receiving the reference voltage Vref4, and is configured to output a comparison signal VC2 according to a comparison result of the reference voltage Vref4 and the first feedback voltage VOUT*0.125 of the output voltage VOUT.

The buffer 2213 has a non-inverting input for receiving the second feedback voltage VOUT*0.5 of the output voltage VOUT, an inverting input being grounded, a first output for outputing the error signal eao, and a second output for generating a duty cycle signal duty by superimposing the second feedback voltage VOUT*0.5 of the output voltage VOUT and the error signal eao.

The comparator 2214 has a non-inverting input for receiving a second preset value V11 (e.g., 1.1V) and an inverting input for receiving the duty cycle signal duty, and is configured to output a comparison signal VC3 according to a comparison result of the first reference voltage V11 and the duty cycle signal duty.

The OR gate 2215 has a first input for receiving the comparison signal VC2 and a second input for receiving the comparison signal VC3, and is configured to output a first logic signal according to the comparison signal VC2 and the comparison signal VC3.

The AND gate 2216 has a first input for receiving the first logic signal and a second input for receiving the clock signal clk1, and is configured to output a second set signal according to the first logic signal and the clock signal clk1.

The RS flip-flop 2217 has a reset terminal R for receiving the comparison signal VC1, a set terminal S for receiving the second set signal, and an output for providing the control signal PFM. When R=1, PFM=0; when R=0, if S=1, PFM=1, and the control signal PFM remains unchanged when S transitions from 1 to 0.

The comparator 2221 has a non-inverting input for receiving the first feedback voltage VOUT*0.125 of the output voltage VOUT and an inverting input for receiving the reference voltage Vref3, and is configured to output a comparison signal VC4 according to the reference voltage Vref3 and the first feedback voltage VOUT*0.125 of the output voltage VOUT.

The AND gate 2222 has a first input terminal for receiving the comparison signal VC4 and a second input terminal for receiving the control signal PFM, and is configured to output the control signal PFM_OSC_D according to the comparison signal VC4 and the control signal PFM.

The NOR gate 2223 has a first input terminal for receiving the clock signal clk1 and a second input terminal for receiving the control signal PFM_OSC_D, and an output for providing the set signal V1.

Wherein, the comparator 2212 determines the timing of the switch converter entering PFM mode during fast load transition from heavy to light, while the buffer 2213 and comparator 2214 determine the timing of the switch converter entering PFM mode during slow load transition from heavy to light.

Further, the synchronized operation of the switch converter with the clock signal clk1 during entering PFM mode facilitates uniform pulse generation at the output voltage VOUT.

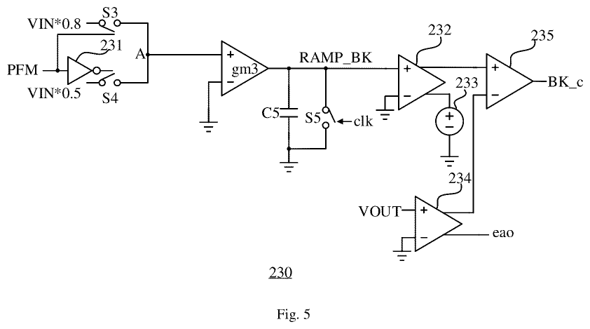

FIG. 5 shows a circuit schematic of the reset signal generation unit according to an embodiment of the present disclosure. As shown in FIG. 5, the reset signal generation unit 230 comprises a switch S3, a switch S4, an inverter 231, a transconductance amplifier gm3, a capacitor C5, a switch S5, a buffer 232, a reference voltage source 233, a buffer 234 and a comparator 235. Wherein, the reference voltage source 232 is configured to provide a reference voltage. The reference voltage is, for example, 1.1V.

The switch S3 has a first terminal for receiving the feedback voltage VIN*0.8 of the input voltage VIN, a second terminal connected to a node A, and a control terminal for receiving the control signal PFM. The switch S4 has a first terminal for receiving the feedback voltage VIN*0.5 of the input voltage VIN, a second terminal connected to a node A, and a control terminal for receiving an inverted control signal PFM from the inverter 231. The switch S3, switch S4 and inverter 231 are configured to converse the feedback voltage of the input voltage VIN which is input to the transconductance amplifier gm3 to the feedback voltage VIN*0.5 or the feedback voltage VIN*0.8 according to the control signal PFM.

The transconductance amplifier gm3 has a receives non-inverting input connected to the node A and an inverting input being grounded, and is configured to differentially amplify a voltage VA at the node A and a ground voltage to obtain differential signal. The capacitor C5 has a first terminal connected to the output of the transconductance amplifier gm3 and a second terminal being grounded. The switch S5 has a first terminal connected to the output of the transconductance amplifier gm3 and a second terminal being grounded. The on and off of the switch S5 is controlled by the clock signal clk. The buffer 232 had a non-inverting input connected to the first terminal of the switch S5, an inverting input being grounded, a first output being grounded through the reference voltage source 233, and a second output for superimposing and outputting a voltage at the first terminal of the switch S5 with reference voltage. The buffer 234 has a non-inverting input for receiving the output voltage VOUT, an inverting input being grounded, a first output for receiving the error signal eao, and a second terminal for superimposing and outputting the output voltage VOUT with the error signal eao. The comparator 235 has a non-inverting input connected to the second output of the second output of the buffer 232, an inverting input connected to the second output of the buffer 234. The comparator 235 is configured to outputting the reset signal BK_c according to a comparison result of the output signal of the buffer 232 and the output signal of the buffer 234.

Wherein, the ramp voltage RAMP_BK is correlated with the output voltage provided by the buffer 232. When the clock signal clk is switched to a logic low level, the switch S5 turns off and the transconductance amplifier gm3 charges the capacitor C5 according to the voltage VA at the node A, causing the ramp voltage RAMP_BK to rise. When the clock signal clk is switched to a logic high level, the switch S5 turns on and the transconductance amplifier gm3 discharges the capacitor C5 according to the voltage VA at the node A, causing the ramp voltage RAMP_BK to drop rapidly to a preset value. The preset value is, for example, zero.

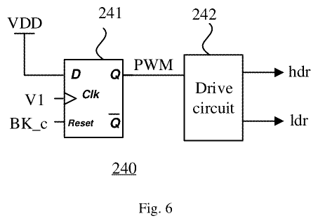

FIG. 6 shows a circuit schematic of the logic and drive unit according to an embodiment of the present disclosure. As shown in FIG. 6, the logic and drive unit 240 comprises D flip-flop 241 and drive circuit 242.

The D flip-flop 241 has a set terminal Clk for receiving the set signal V1, an input D connected to the power supply voltage VDD, a reset terminal reset for receiving the reset signal BK_c, and an output Q for outputting a pulse width modulation signal PWM.

The drive circuit 242 is configured to provide a drive signal hdr and a drive signal ldr according to the pulse width modulation signal PWM.

Wherein, the D flip-flop 241 synchronizes the data at the input D to the output Q on the rising edge of the set terminal Clk, and resets the output Q to zero when the reset signal BK_c is equal to 1, wherein the clock signal clk is synchronized with the timing at the set terminal clk.

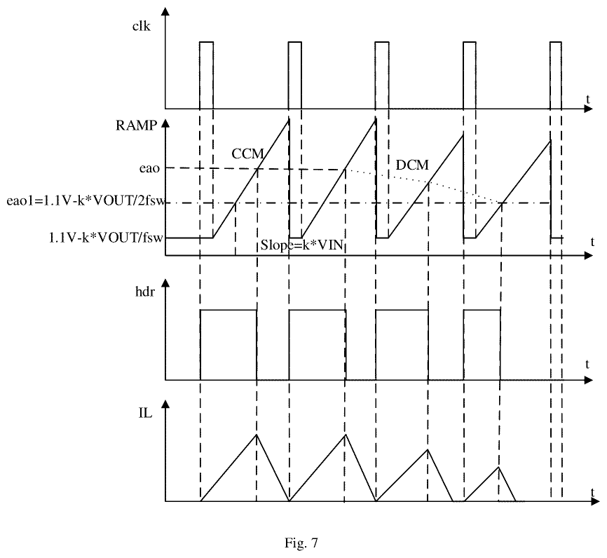

FIG. 7 shows a timing diagram of the switch converter according to an embodiment of the present disclosure. The following describes the control circuit operation with reference to FIG. 7.

During gradual load reduction from heavy to light, the first feedback voltage VOUT*0.125 of the output voltage VOUT exceeds the reference voltage Vref1, causing the inductor current IL to transition from CCM mode to DCM mode (that is, VC1 transitions from 1 to 0). The equivalent duty cycle of the drive signal hdr is reduced, so that the error signal eao is reduced. When the equivalent duty cycle of the drive signal hdr under DCM mode equals half of the equivalent duty cycle of the drive signal hdr under CCM mode, the error signal eao 1=1.1V-k* VOUT/2fsw, VC3=1, the RS flip-flop 227 outputs the control signal PFM with a logic level of 1, so that the switch converter enters PFM mode. At this time, the voltage input to the transconductance amplifier gm3 switches from the feedback voltage VIN*0.5 of the input voltage VIN to the feedback voltage VIN*0.8 of the input voltage VIN. At the same time, the switch S1 and the switch S2 are turned on, the operating point of the error signal eao is set to the first preset value (i.e. 1.1V) to reduce the loop recovery time when exiting PFM mode, thereby reducing the ripple amplitude of the output voltage VOUT. During abrupt load reduction from heavy to light, the first feedback voltage VOUT*0.125 of the output voltage VOUT exceeds the reference voltage Vref1, causing the inductor current IL to transition from CCM mode to DCM mode (that is, VC1 transitions from 1 to 0). Although the error signal eao changes slowly, the first feedback voltage VOUT*0.125 of the output voltage VOUT exceeds the reference voltage Vref4 (that is, VC2=1), the RS flip-flop 227 will also output the control signal PFM with the logic level of 1, so that the switching converter enters PFM mode. Therefore, the control circuit of the switch converter according to the present disclosure accurately can accurately set the load level entering PFM during gradual load reduction from heavy to light, and has a fast transient response during abrupt load reduction from heavy to light.

When transitioning from light to heavy load, the first feedback voltage VOUT*0.125 of the output voltage drops below the reference voltage Vref1, causing the control signal PFM to become 0 and the switch converter to exit PFM mode. At this time, the switch S1 and the switch S2 turn off, and the error signal eao operates around 1.1V through loop control. The ramp voltage RAMP_BK returns to normal slope, enabling direct energy transfer to output and reducing voltage ripple of the output voltage while improving response speed.

Accordingly, the present disclosure further provides a control method for the switch converter.

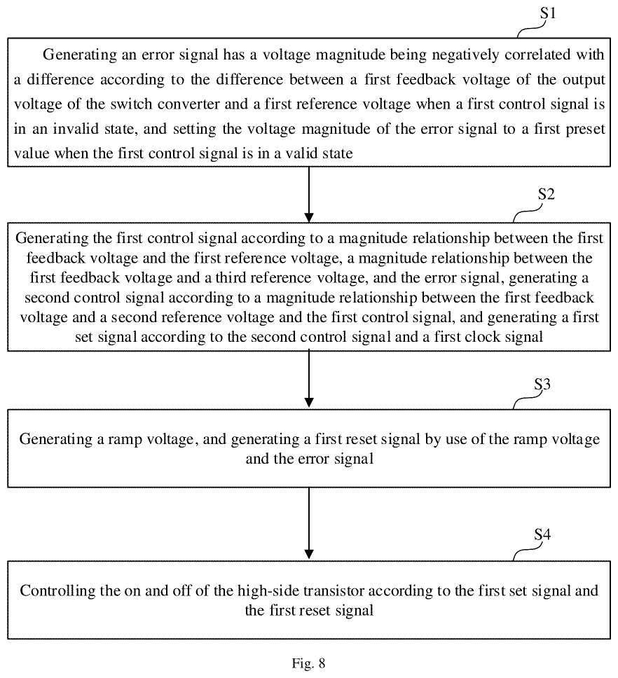

FIG. 8 shows a flowchart of the control method according to an embodiment of the present disclosure. The method applies to the above-mentioned switch converter and comprises:
Step S1: generating an error signal eao has a voltage magnitude being negatively correlated with a difference between a first feedback voltage VOUT*0.125 of the output voltage VOUT of the switch converter and a reference voltage Vref1 when a control signal PFM is in an invalid state, and setting the voltage magnitude of the error signal eao to a first preset value when the control signal PFM is in a valid state;
Step S2: generating the control signal PFM according to a magnitude relationship between the first feedback voltage VOUT*0.125 and the reference voltage Vref1, a magnitude relationship between the first feedback voltage VOUT*0.125 and a reference voltage Vref4 (e.g. Vref1+30mV), and the error signal eao, generating a control signal PFM_OSC_D according to a magnitude relationship between the first feedback voltage VOUT*0.125 and a reference voltage Vref3 (e.g. Vref1+10mV) and the control signal PFM, and generating a set signal V1 according to the control signal PFM_OSC_D and a clock signal clk1;
Step S3: generating a ramp voltage RAMP_BK, and generating a reset signal BK_c by use of the ramp voltage RAMP_BK and the error signal eao;
Step S4: controlling the on and off of the high-side transistor MH according to the set signal V1 and the reset signal BK_c.

As described in the embodiments above, the present disclosure does not exhaustively describe all details nor limit the present disclosure to the specific embodiments. Clearly, numerous modifications and variations are possible. This specification selects and describes certain embodiments to better explain the present disclosure's principles and practical applications, enabling those skilled in the art to utilize the present disclosure and its modifications. The scope of protection for the present disclosure shall be determined by the claims and their equivalents.

1. A control circuit for a switch converter, wherein the switch converter comprises a high-side transistor and an inductor, the control circuit controls an energy transfer from an input voltage to an output voltage by controlling on and off of the high-side transistor, and the control circuit comprises:
an error signal generation unit, for generating an error signal has a voltage magnitude being negatively correlated with a difference between a first feedback voltage of the output voltage of the switch converter and a first reference voltage when a first control signal is in an invalid state, and setting the voltage magnitude of the error signal to a first preset value when the first control signal is in a valid state;
a PFM control unit, for generating the first control signal according to a magnitude relationship between the first feedback voltage and the first reference voltage, a magnitude relationship between the first feedback voltage and a third reference voltage, and the error signal, generating a second control signal according to a magnitude relationship between the first feedback voltage and a second reference voltage and the first control signal, and generating a first set signal according to the second control signal and a first clock signal, wherein the second reference voltage is greater than the first reference voltage and less than the third reference voltage;
a reset signal generation unit, for generating a ramp voltage, and generating a first reset signal by use of the ramp voltage and the error signal;
a logic and drive unit, for controlling the on and off of the high-side transistor according to the first set signal and the first reset signal,
wherein the second control signal is related to a load level of the switch converter.

2. The control circuit according to claim 1, wherein the PFM control unit is configured to:
when the first control signal is in the invalid state, if a voltage magnitude of the error signal meets a preset condition, control the first control signal to change to the valid state;
when the first control signal is in the invalid state, if the first feedback voltage is greater than the third reference voltage, control the first control signal to change to the valid state;
when the first control signal is in the valid state, if the first feedback voltage is less than the first reference voltage, control the first control signal to change to the invalid state.

3. The control circuit according to claim 2, wherein the preset condition comprises a sum of the voltage magnitude of the error signal and a second feedback voltage of the output voltage being less than a second preset value;
wherein, when the sum of the voltage magnitude of the error signal and the second feedback voltage of the output voltage is equal to the second preset value, if the switch converter is in DCM mode, an equivalent duty cycle of the high-side transistor of the switch converter reaches a preset ratio with the equivalent duty cycle of the high-side transistor of the switch converter in CCM mode, and the preset ratio is less than 1.

4. The control circuit according to claim 1, wherein the PFM control unit comprises:
a first comparator having a non-inverting input receiving the first reference voltage, an inverting input receiving the first feedback voltage, and an output for providing a first comparison signal;
a first buffer having a non-inverting input receiving the second feedback voltage of the output voltage, an inverting input being grounded, a first output receiving the error signal, and a second output for providing a duty cycle signal, the duty cycle signal being obtained by superimposing the second feedback voltage of the output voltage and the error signal, the second feedback voltage of the output voltage being greater than the first feedback voltage of the output voltage;
a second comparator having a non-inverting input receiving a second preset value, an inverting input receiving the duty cycle signal, and an output terminal for providing a second comparison signal;
a third comparator having a non-inverting input receiving the first feedback voltage, an inverting input receiving the third reference voltage, and an output for providing a third comparison signal;
an OR gate having a first input receiving the third comparison signal, a second input receiving the second comparison signal, and an output for providing a first logic signal;
a first AND gate having a first input receiving the first logic signal, a second input receiving a first clock signal, and an output for providing a second set signal;
a first flip-flop having a reset terminal receiving the first comparison signal, a set terminal receiving the second set signal, and an output for providing the first control signal;
a fourth comparator having a non-inverting input receiving the first feedback voltage, an inverting input receiving the second reference voltage, and an output for providing a fourth comparison signal;
a second AND gate having a first input receiving the fourth comparison signal, a second input receiving the first control signal, and an output for providing the second control signal;
a NOR gate having a first input receiving the first clock signal, a second input receiving the second control signal, and an output for providing the first set signal.

5. The control circuit according to claim 1, wherein the error signal generation unit comprises:
a first transconductance amplifier having a non-inverting input receiving the first feedback voltage of the output voltage and an inverting input receiving the first reference voltage, and the first transconductance amplifier being configured to differentially amplify the first feedback voltage of the output voltage and the first reference voltage;
an amplification unit for amplify an output of the first transconductance amplifier;
a compensation unit for compensating an output of the amplification unit;
an output unit, comprising:
a second transconductance amplifier having a non-inverting input receiving a fourth reference voltage and an inverting input connected to the compensation unit;
a first switch connected between the non-inverting input and the inverting input of the second transconductance amplifier; and
a first reference voltage source and a second switch sequentially connected between the output terminal of the second transconductance amplifier and ground, the first reference voltage source being used to provide the first preset value,
wherein the first switch and the second switch are controlled by the first control signal.

6. The control circuit according to claim 1, wherein the reset signal generation unit is configured to: generate the ramp voltage with a first slope according to a second clock signal when the first control signal is in the invalid state; generate the ramp voltage with a second slope according to the second clock signal when the first control signal is in the valid state, the first slope being less than the second slope.

7. The control circuit according to claim 1, wherein the reset signal generation unit comprises:
a third switch having a first terminal receiving a third feedback voltage of the input voltage, a second terminal connected to a first node, and a control terminal receiving the first control signal;
a fourth switch having a first terminal receiving a fourth feedback voltage of the input voltage, a second terminal connected to the first node, the third feedback voltage of the input voltage being greater than the fourth feedback voltage of the input voltage;
an inverter, connected between the first control signal and a control terminal of the fourth switch;
a third transconductance amplifier having a non-inverting input connected to the first node and an inverting input being grounded, configured to differentially amplify a voltage at the first node and a ground voltage to obtain a differential signal;
a first capacitor having a first terminal connected to an output of the third transconductance amplifier and a second terminal being grounded;
a fifth switch having a first terminal connected to the first terminal of the first capacitor, a second terminal being grounded, and a control terminal receiving a second clock signal;
a second buffer having a non-inverting input connected to the first terminal of the fifth switch, an inverting input being grounded, a first output being grounded through a second reference voltage source, and a second output for outputting a voltage obtained by superimposing a voltage at the first terminal of the fifth switch and a voltage provided by the second reference voltage source;
a third buffer having a non-inverting input connected to the output voltage, an inverting input being grounded, a first output receiving the error signal, and a second output for outputting a voltage obtained by superimposing the output voltage and the error signal;
a fifth comparator having a non-inverting input connected to the second output of the second buffer, an inverting input connected to the second output terminal of the third buffer, and an output for providing the first reset signal.

8. The control circuit according to claim 1, wherein the logic and drive unit comprises:
a second flip-flop having a set terminal receiving the first set signal, a reset terminal receiving the first reset signal, and an output for providing a PWM signal;
a drive circuit, configured to provide a drive signal according to the PWM signal to control the on and off of the high-side transistor.

9. A switch converter, comprising:
the control circuit according to claim 1; and
a power stage circuit, comprising:
a high-side transistor and an inductor, the power stage circuit controlling the energy transfer from the input voltage to the output voltage by controlling the on and off of the high-side transistor.

10. A control method for a switch converter, wherein the switch converter comprises a high-side transistor and an inductor, the control circuit controls an energy transfer from an input voltage to an output voltage by controlling on and off of the high-side transistor, and the control method comprises:
generating an error signal has a voltage magnitude being negatively correlated with a difference between a first feedback voltage of the output voltage of the switch converter and a first reference voltage when a first control signal is in an invalid state, and setting the voltage magnitude of the error signal to a first preset value when the first control signal is in a valid state;
generating the first control signal according to a magnitude relationship between the first feedback voltage and the first reference voltage, a magnitude relationship between the first feedback voltage and a third reference voltage, and the error signal, generating a second control signal according to a magnitude relationship between the first feedback voltage and a second reference voltage and the first control signal, and generating a first set signal according to the second control signal and a first clock signal, wherein the second reference voltage is greater than the first reference voltage and less than the third reference voltage;
generating a ramp voltage, and generating a first reset signal by use of the ramp voltage and the error signal;
controlling the on and off of the high-side transistor according to the first set signal and the first reset signal,
wherein the second control signal is related to a load level of the switch converter.
